(19) United States
(12) Patent Application Publication
(10) Pub. No.: US 2026/0264508 A1
(43) Pub. Date: Sep. 10, 2026

(54) ELECTRIC DRIVE SYSTEM HAVING WHEEL PLANETARY REDUCERS

(71) Applicants: FCA US LLC, Auburn Hills, MI (US); Stellantis Auto SAS, Poissy (FR)

(72) Inventors: Lucien Duplessis, Auburn Hills, MI (US); Pradeep Attibele, Auburn Hills, MI (US); Mark A. Levine, Auburn Hills, MI (US); Travis D. Bechtel, Auburn Hills, MI (US); Zachary Luetzen, Auburn Hills, MI (US)

(21) Appl. No.: 19/073,603

(22) Filed: Mar. 7, 2025

(51) Int. Cl. B60K 17/04; B60K 1/02

(52) U.S. Cl. CPC B60K 17/046; B60K 1/02

(57) ABSTRACT

An electric drive system for an electrified vehicle includes a driveline, a first motor, a first wheel-end planetary reducer, and a second wheel-end planetary reducer. The driveline includes a first drive shaft that drives a first drive wheel and a second drive shaft that drives a second drive wheel. The first electric motor has a first primary output shaft. The first wheel-end planetary reducer provided at the first drive wheel, the first wheel-end planetary reducer providing a first gear reduction from the first drive shaft to a first wheel shaft at the first drive wheel. The second wheel-end planetary reducer provided at the second drive wheel, the second wheel-end planetary reducer providing a second gear reduction from the second drive shaft to a second wheel shaft at the second drive wheel. The first and second wheel-end planetary reducers are modular and removable between respective drive shafts and wheel shafts.

### FIELD

The present application relates generally to electric drive systems for electric vehicles and, more particularly, to wheel planetary reducers configured for an electrified vehicle.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) converter.

Electric vehicles can have electric motors configured in various arrangements. Some electric vehicles have a single electric motor dedicated to a drive axle. All-wheel-drive electric vehicles can have multiple electric motors such as one or more dedicated to a front and/or rear drive axle. Some arrangements include a dedicated electric motor for each drive wheel. Regardless of the arrangement, it can be desirable to provide a configuration that offers suitable drive torque depending upon vehicle type. In doing so, it can be challenging to configure an electrified powertrain for high torque and high power electric motors as the packaging requirements can be a limiting factor. Electric drive motors or transmissions typically include a differential and gear reductions. By locating such gear reductions at or near the electric motor, packaging challenges can exist. Accordingly, while such electrified powertrains work well for their intended purpose, there is a desire for improvement in the relevant art.

### SUMMARY

In accordance with one example aspect of the invention, an electric drive system for an electrified vehicle includes a driveline, a first motor, a first wheel-end planetary reducer, and a second wheel-end planetary reducer. The driveline includes a first drive shaft that drives a first drive wheel and a second drive shaft that drives a second drive wheel. The first electric motor has a first primary output shaft. The first wheel-end planetary reducer provided at the first drive wheel, the first wheel-end planetary reducer providing a first gear reduction from the first drive shaft to a first wheel shaft at the first drive wheel. The second wheel-end planetary reducer provided at the second drive wheel, the second wheel-end planetary reducer providing a second gear reduction from the second drive shaft to a second wheel shaft at the second drive wheel. The first and second wheel-end planetary reducers are modular and removable between respective drive shafts and wheel shafts.

In addition to the foregoing, the first wheel-end planetary reducer comprises a first housing that houses a planetary gear set including a sun gear, a carrier that supports a plurality of pinion gears, and a ring gear.

In additional features, the electric drive system further comprises a first coupling that couples the first drive shaft to the sun gear.

In other implementations, the electric drive system further comprises a second coupling that couples the first wheel shaft to the first drive wheel.

In other examples, the electric drive system further comprises a first bearing that supports the sun gear.

In additional implementations, the electric drive system further comprises at least one second bearing that supports the first wheel shaft.

In addition to the foregoing, in one configuration the first and second gear reductions are equivalent.

In addition to the foregoing, the first and second gear reductions both comprise one of 6:1; 7:1; and 8:1 gear ratios.

In examples, the electric drive system further includes a second electric motor having a second primary output shaft; and a third electric motor positioned between the first and second electric motors, the third electric motor having a first output shaft that provides a first torque input to the first motor and a second output shaft that provides a second torque input to the second motor.

In other implementations, the electric drive system further includes a differential disposed in the third electric motor, the differential providing selective speed differentiation between the first and second output shafts.

In other implementations, the differential comprises a first side gear that drives the first output shaft, a second side gear that drives the second output shaft and a plurality of planet gears that are meshed for rotation with the first and second side gears.

In other implementations, the first, second and third electric motors are co-axially arranged on a rear axle of the electrified vehicle.

In additional examples, the first, second and third electric motors are co-axially arranged on a front axle of the electrified vehicle.

In other configurations, the first electric motor drives the first drive shaft and the second electric motor drives the second drive shaft, the first and second electric motors providing torque vectoring between the first and second drive wheels.

In accordance with another example aspect of the invention, an electric drive system for an electrified vehicle includes a driveline, a first electric motor, a pair of first wheel-end planetary reducers, and a pair of second wheel-end planetary reducers. The driveline includes a first drive shaft that drives a first drive wheel and a second drive shaft that drives a second drive wheel. The first electric motor having a first primary output shaft. The pair of first wheel-end planetary reducers each having a first gear ratio reduction. The pair of second wheel-end planetary reducers each having a second gear ratio reduction. The electric drive system is configurable in each of: a first configuration for achieving the first gear ratio reduction, wherein one of the pair of first wheel-end planetary reducers is installed between the first drive shaft and the first drive wheel and the other of the pair of first wheel-end planetary reducers is installed between the second drive shaft and the second drive wheel; and a second configuration for achieving the second gear ratio reduction, wherein one of the pair of second wheel-end planetary reducers is installed between the first drive shaft and the first drive wheel and the other of the pair of second wheel-end planetary reducers is installed between the second drive shaft and the second drive wheel.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric drive system including a drive module system and a wheel reducer system, the drive module system shown having first, second and third (center) axially arranged motors in accordance with the principles of the present application;

FIG. 2 is a front perspective view of the drive module system shown in FIG. 1, shown in a first configuration with all of the first, second and third motors operably coupled, in accordance with the principles of the present application;

FIG. 3 is a front perspective view of the drive module system shown in FIG. 1, shown in a second configuration with the center electric motor removed, in accordance with the principles of the present application;

FIG. 4 is a perspective detail view of the center electric motor, in accordance with the principles of the present application;

FIG. 5 is a side view of an electric motor disconnect system constructed in accordance to one example of the present disclosure and shown with first and second collars in the decoupled position;

FIG. 6 is a side view of the electric motor disconnect system of FIG. 5 and shown with first and second collars in the coupled position, in accordance with the principles of the present application;

FIG. 7 is a perspective view of a wheel-end planetary reducer in accordance with the principles of the present application;

FIG. 8 is a sectional view of the wheel-end planetary reducer taken along lines 8-8 of FIG. 7; and

FIG. 9 represents sectional views of a plurality of wheel-end planetary reducers each having a different gear reduction.

### DETAILED DESCRIPTION

As noted above, it can be desirable to provide an electric motor configuration that offers suitable drive torque depending upon vehicle type. In doing so, it can be challenging to configure an electrified powertrain for high torque and high power electric motors as the packaging requirements can be a limiting factor. Moreover, existing configurations do not allow for modularity when more than one configuration may be desired for the same vehicle type. Additionally, electric drive motors or transmissions typically include a differential and gear reductions which presents packaging challenges.

The present disclosure provides a modular electric drive system that incorporates a drive module having electric motors arranged in series. The configuration disclosed herein eliminates a reducer from the powertrain and moves it to the wheel end allowing the reducer to be a separate, serviceable component while reducing the torque transferred through the drivetrain to the wheels. A reduction in torque allows the downsizing of the components between the powertrain and the reducer, which permits smaller shaft cross sections. The configurations herein promote modularity and ease of serviceability. In this regard, by moving the reducers to the wheels, they will be accessible for service, replacement, or modification without the need to remove or disassemble the powertrain.

By way of example, the electric motors can be any electric motors including axial flux motors, radial flux motors and other electric motors, or a combination of different motor topologies. While the examples herein are axial flux motors, the requirements could also be met with appropriately designed motors of different topology (e.g., radial flux, transverse flux, or some other different configuration). In a first configuration, three motors are arranged co-axially in series. As axial flux motors take up significantly less space (axially), three motors are arranged co-axially side-by-side and can collectively fit between the rails of most allowable packaging spaces. The center motor of the three axial motors includes an internal differential. The three axial flux motor configuration can be particularly suitable in high performance vehicles. The three axial flux motor configuration can be incorporated at the rear axle and/or the front axle and would include controls that optimize the torque and power as well as efficiency for a given accelerator pedal request. The electric drive system further provides a wheel reducer system having in-wheel reducers that can be changed and/or customized to meet specific vehicle needs to satisfy low speed torque or top end speed. In additional implementations, the in-wheel reducers can be two-speed reducers allowing the configuration to balance a maximum vehicle speed and low speed torque requirements as needed. The drive module can also be adapted in a second configuration where the center motor is removed leaving two axial flux motors.

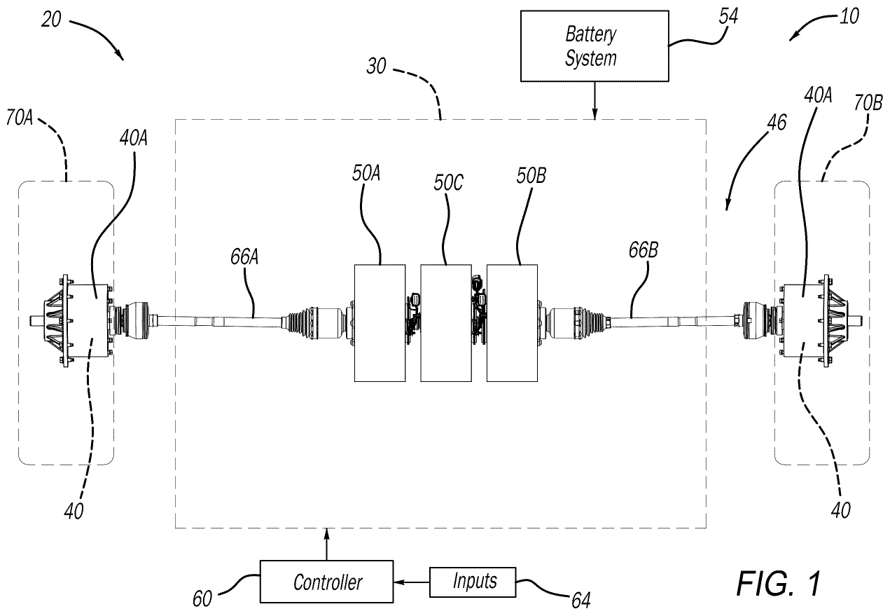

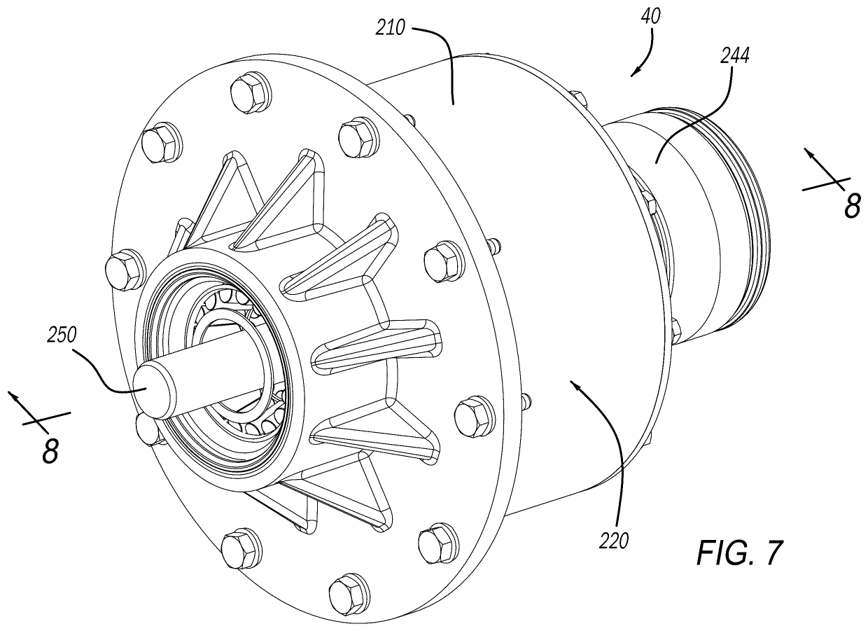

With initial reference to FIG. 1, a vehicle 10 is partially shown in accordance with the principles of the present disclosure. In the example embodiment, vehicle 10 includes an electric drive system 20 having a drive module system 30 and a wheel reducer system, collectively identified at reference numeral 40. The drive module system 30 is configured to generate and transfer drive torque to a driveline 46 for vehicle propulsion. The wheel reducer system 40 disclosed herein is a wheel-end planetary reducer 40 further described herein and shown at FIGS. 7-9.

The drive module system 30 is shown in a first configuration having a first electric drive motor 50A, a second electric drive motor 50B and a third electric drive motor 50C. In the first configuration, the first and second drive motors 50A and 50B are arranged on opposing axial sides of the third, or center, drive motor 50C. The electric motors 50A-50C are connectable via a power inverter module (not specifically shown) to a high voltage battery system 54. A controller 60 can communicate signals to the drive module system 30 indicative of a torque request based on inputs 64 (e.g., such as from an accelerator pedal). While the electric motors 50A-50C are described herein as axial flux motors, it will be appreciated that other motor configurations such as, but not limited to, radial flux motors may be used.

The exemplary driveline 46 includes a first drive shaft 66A, a second drive shaft 66B, the wheel reducer system 40 and drive wheels 70A and 70B. The wheel reducer system 40 includes a first wheel reducer 40A arranged at the first drive wheel 70A and a second wheel reducer 40B arranged at the second drive wheel 70B. The first and second wheel reducers 40A and 40B allow the respective shafts 60A and 60B to be minimally sized since the final increase in torque will be accomplished by the wheel reducers 40A and 40B in the wheels 70A and 70B, respectively.

In the examples shown, the wheel reducers can provide predetermined gear ratios selected for various vehicle types. For example, but not limited to, gear ratios of 3:1, 6:1 and others may be used. The gear ratios can be achieved with any gearing arrangement such as, but not limited to planetary gear sets. As will become appreciated herein, the wheel reducers 40A, 40B can be swapped out for other wheel reducers having different gear ratios that may be particularly suited for a particular vehicle application. Furthermore, the wheel reducers 40A, 40B can be swapped out based on whether the axial motor configuration is in the first configuration (three side-by-side), or in a second configuration (center motor removed).

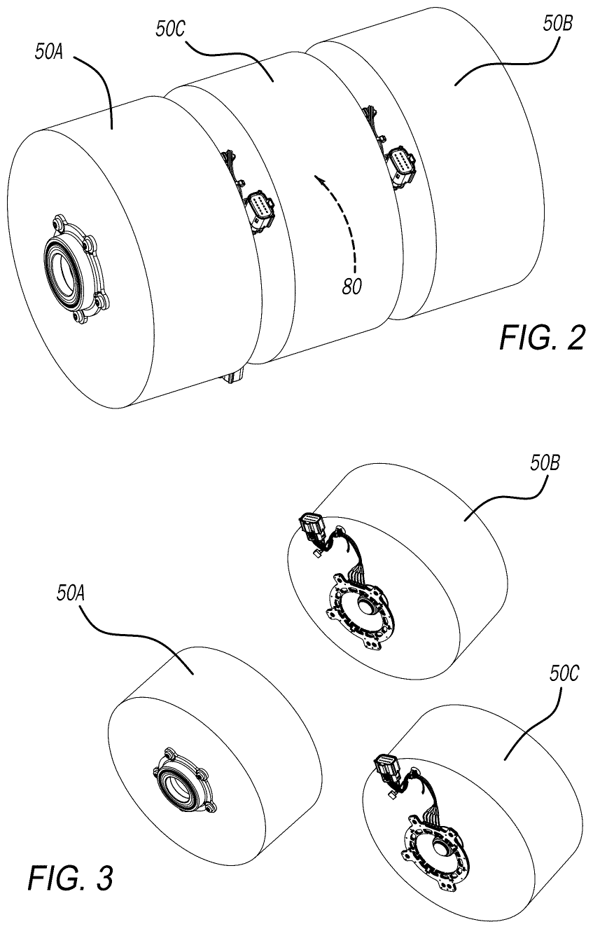

With continued reference to FIG. 1 and additional reference to FIGS. 2 and 3, additional features of the instant disclosure will be described. FIG. 2 is a front perspective view of the drive module system shown in FIG. 1, shown in a first configuration with all of the first, second and third motors 50A, 50B and 50C operably coupled. FIG. 3 is a front perspective view of the drive module system shown in FIG. 1, shown in a second configuration with the center motor 50C removed. Having two outboard electric motors 50A, 50B going directly to each wheel 70A, 70B allows for torque vectoring while the third center motor 50C adds torque and power to the system without compromising the torque vectoring capabilities.

The electric drive system 20 is modular and easily adaptable to configure dependent upon vehicle type. In this regard it is contemplated that an electric drive system 20 can be used in multiple configurations such as a first configuration (FIG. 2) in a high performance vehicle (such as using all three coaxial motors and appropriately geared wheel reducers), or in a second configuration (FIG. 3) in a lower power application, such as by using only the two motors 50A and 50B without the center motor 50C and appropriately geared wheel reducers.

As mentioned herein, the electric drive system 20 can be configured on either a front or rear drive axle of the driveline. In some configurations, the electric drive system 20 can be arranged on both the front and rear drive axles for a four-wheel drive or all-wheel drive driveline vehicle.

The center motor 50C includes a differential 80 that provides speed differentiation between a first output shaft 82A and a second output shaft 82B. In the example shown, the first output shaft 82A can provide a torque input to the motor 50A. Similarly, the second output shaft 82B can provide a torque input to the motor 50B. While the differential 80 can be arranged in any manner, the exemplary differential 80 generally includes a first side gear 84A that drives the first output shaft 82A, a second side gear 84B that drives the second output shaft 82B, and a collection of planet gears 86 that mesh with both of the side gears 84A and 84B. The differential 80 splits torque evenly to the first and second output shafts 82A, 82B, assuming no tire slip, while allowing speed differentiation during turning. The differential 80 can be relatively small in size since it is only accommodating the torque of the center motor 50C and is located in the torque path before the gear reduction.

As described above, the electric motors 50A, 50B and 50C are axial flux motors. Axial flux motors can be larger in diameter but significantly less wide (axially) while achieving power and torque levels of a radial flux motor (which is the architecture used in most electric vehicles). The in-wheels reducers 40A, 40B significantly reduce the packaging space required for the electric motors as all the gearing is performed in the wheels, rather than the motor housing. This advantage allows end users to target specific performance needs based on their individual requirements. For example, high performance vehicle drivers may want to modify their vehicles for many purposes, such as, but not limited to, drag racing, track racing, daily driving, economy driving etc.

Similarly, off-road vehicle drivers can have various off-road gearsets based on vehicle weight as well as ratios for daily travel. In examples, a user may install an economy gearset wheel reducer system 40 to get to the trail and subsequently change the wheel reducer system to increase the torque available for off-roading. This availability eliminates the need for a two speed gearbox. An off-road gearset would only “need” to be purchased if desired by the user. This eliminates being limited to the one or two speed gearbox selection at the time of original vehicle purchase for the life of the vehicle. The drive module system 30 allows for future electric motor designs that may have significantly more power and torque.

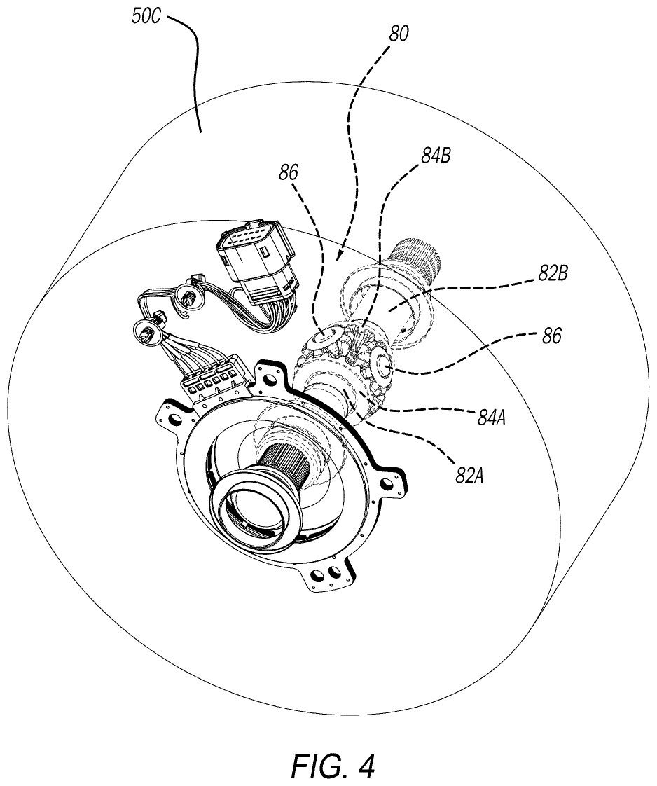

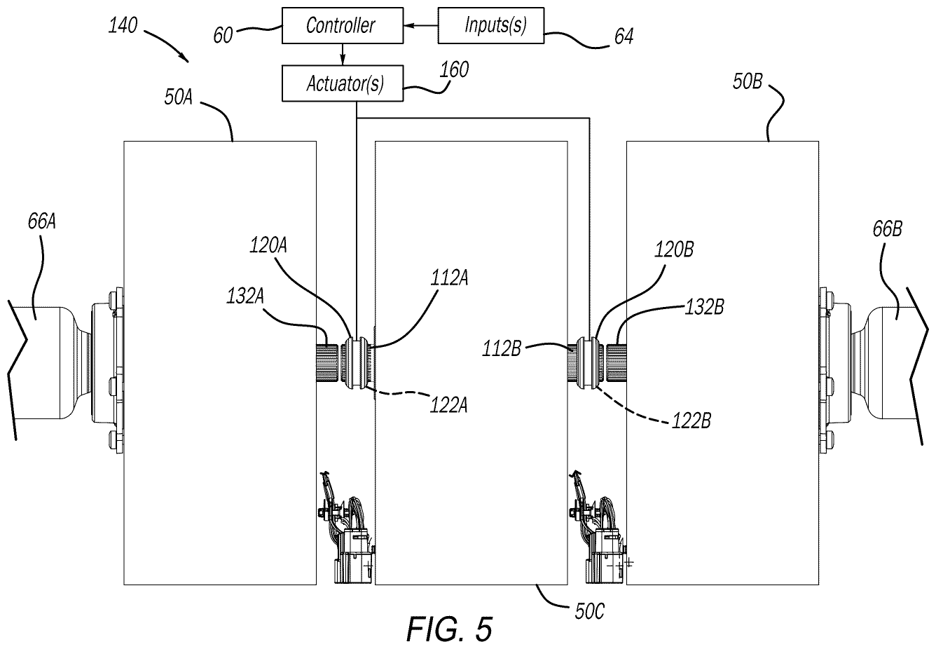

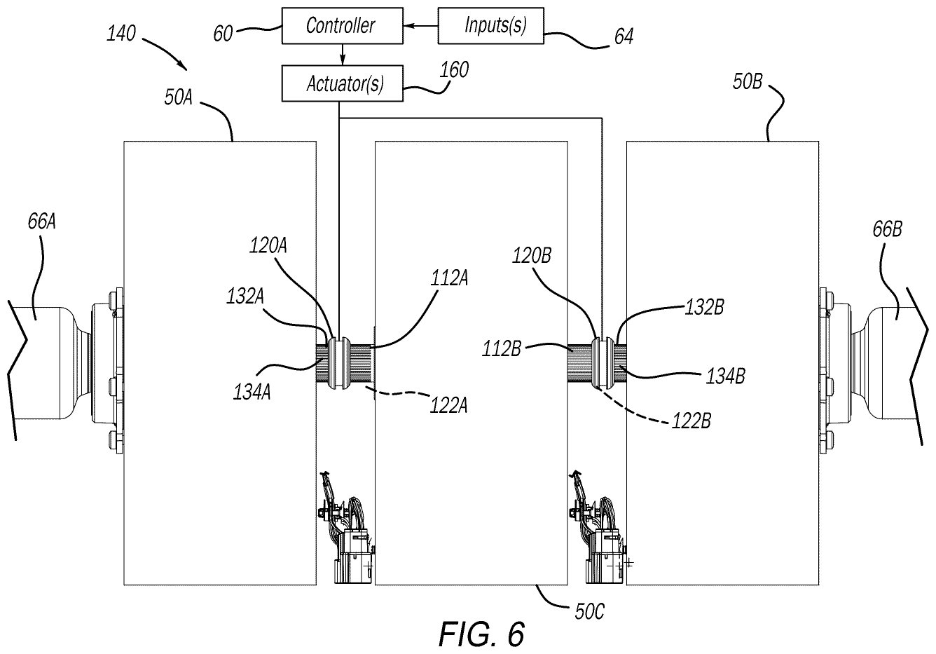

With continued reference to FIG. 4, and additional reference now to FIGS. 5 and 6, an electric motor disconnect system 140 constructed in accordance to one example of the present disclosure will be described. The first output shaft 82A of the center motor 50C defines first splines 112A thereon. The second output shaft 82B of the center motor 50C defines second splines 112B thereon. First and second collars 120A and 120B are shown in a decoupled position in FIG. 5. The first and second collars 120A and 120B define third and fourth splines 122A and 122B thereon. In the example shown, the first and second splines 112A and 112B are defined on an outer diameter of the output shafts 82A and 82B while the third and fourth splines 122A and 122B are defined on an inner diameter of the respective collars 120A and 120B. It will be appreciated that the splines may be defined differently such as in an opposite configuration, or be defined by other structures. The outboard motors 50A and 50B include fourth and fifth splines 132A and 132B on primary output shafts 134A and 134B, respectively.

The electric motor disconnect system 140 includes the controller 60 and actuators 160. The controller 60 receives inputs 64. The inputs 64 can be a driver initiated input that requests a drive mode change between a single motor drive mode (e.g., propulsion achieved exclusively from the center motor 50C), to a three motor drive mode (e.g., propulsion achieved from the center motor 50C and the outboard motors 50A and 50B). Operation in the single motor drive mode is shown at FIG. 5 with the collars 120A and 120B in the disconnected position.

When an input is received by the controller 60 indicative of a desire to operate in the three motor drive mode, the controller 60 sends a signal to the actuator(s) 160 to move the collars 120A and 120B from the decoupled position shown in FIG. 5 to the coupled position shown in FIG. 6. As can be appreciated, by translating the collars 120A, 120B to the coupled position shown in FIG. 6, the second and third splines 122A and 122B on the collars 120A and 120B mate with the fifth and sixth splines 132A and 132B on the outboard motors 50A and 50B. Specifically, the third splines 122A on the collar 120A are fixed for rotation with the first splines 112A on the center motor 50C and the fifth splines 132A on the outboard motor 50A. Similarly, the fourth splines 122B on the collar 120B are fixed for rotation with the second splines 112B on the center motor 50C and the sixth splines 132B on the outboard motor 50B.

The actuator(s) 160 can include any mechanical and/or electrical device(s) that enact translation of the collars 120A and 120B between the connected and disconnected positions. In examples, the controller 60 and actuator(s) can synchronize timing for optimal shifting between the connected and disconnected positions. In implementations, alignment of all of the first, third and fifth splines 112A, 122A and 132A can be confirmed prior to actuation of the collar 120A into the connected position. Similarly, alignment of all of the second, fourth and sixth splines 112B, 122B and 132B can be confirmed prior to actuation of the collar 120B into the connected position.

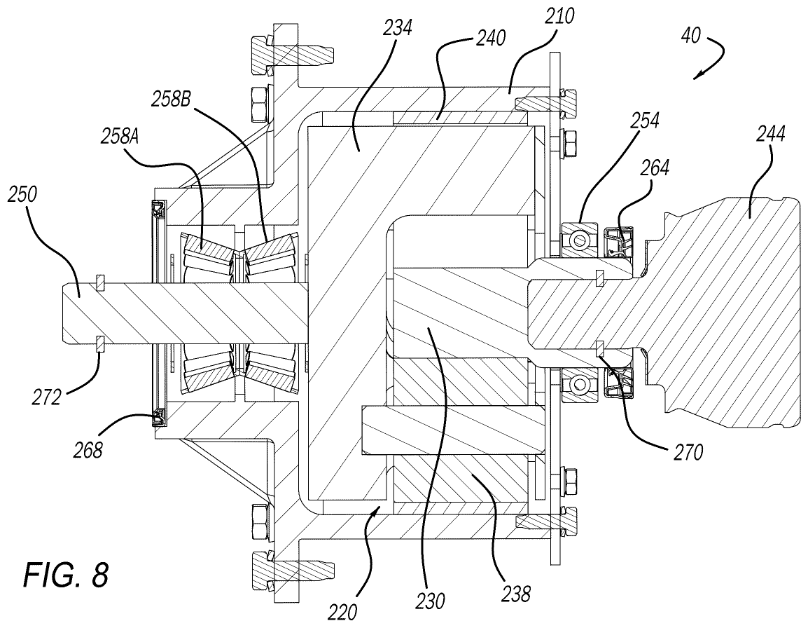

With additional reference now to FIGS. 7-8, additional features of the wheel-end planetary reducer 40 will be described. The wheel-end planetary reducer 40 is packaged in each drive wheel. In this regard, and as shown in FIG. 1, a first wheel-end planetary reducer 40A is packaged at first drive wheel 70A and a second wheel-end planetary reducer 40B is packaged at second drive wheel 70B. By packaging the wheel-end planetary reducers 40 at the wheel, more room is created for the electric motors in the center of the vehicle. Furthermore, the torque being transferred through the propeller/constant velocity (CV) shafts is reduced which allows them to be downsized to reduce weight and material costs. The configuration permits the easy removal and installation of the reducer to provide modularity for different gear ratio reducer modules. The configuration allows for servicing or replacement of the gearsets (i.e., gear ratio), or simply swapping from one planetary module to another. The configuration permits a narrower spring-mass chassis and longer control arms, which is a key enabler for chassis tuning.

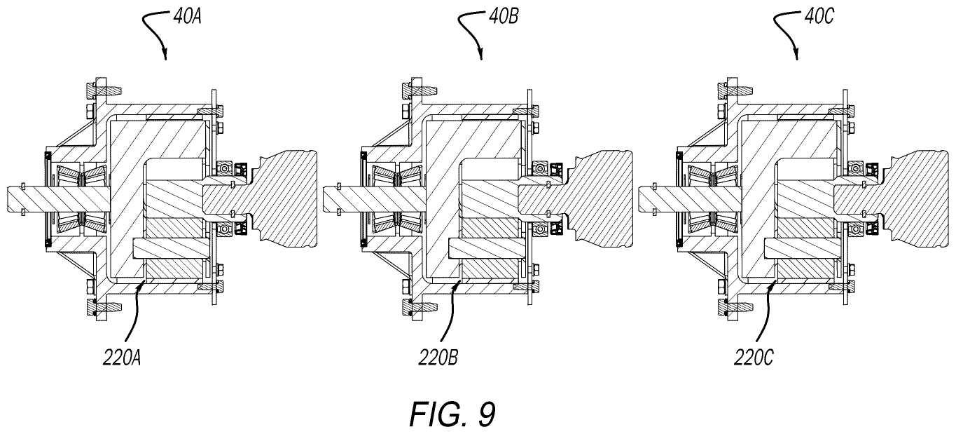

The wheel-end planetary reducer 40 generally includes a housing 210 that houses a planetary gear set 220. The planetary gear set 220 can have various reduction ratios such as, but not limited to, 4:1, 5:1, 6:1, 7:1, 8:1 or 9:1. Other ratios may be used. By way of example only, FIG. 9 illustrates three wheel-end planetary reducers 40A, 40B and 40C, each having a distinct gear ratio offered by the respective planetary gear sets 220A, 220B and 220C. For illustrative purposes, each of the wheel-end planetary reducers 40A, 40B and 40C are shown coupled to respective CV shafts and wheel shafts. In practice it is contemplated that the wheel-end planetary reducers 40A, 40B, 40C will be stand-alone self-contained assemblies ready for connecting to respective CV shafts and wheel shafts already existing in the vehicle 10.

As can be appreciated, the system disclosed herein is modular whereby a user can swap out wheel-end planetary reducers 40 such as to achieve a different gear ratio that is better suited for a given application (e.g., off-roading, highway, etc.). It is appreciated that each of the wheel-end planetary reducers 40A, 40B and 40C are provided in pairs. In this regard, a user would select two common wheel-end planetary reducers (such as 40A having the same gear reduction ratio) for installing at the drive wheels 70A, 70B.

The planetary gear set 220 of the wheel-end planetary reducer 40 includes a sun gear 230, a carrier 234 that supports a plurality of pinion gears 238, and a ring gear 240. In the example shown, the sun gear is driven by a CV shaft 244. The CV shaft 244 is also referred to herein generally as a drive shaft. A wheel shaft 250 acts as an output of the planetary gear set 220 and drives the drive wheel 70. The CV shaft 244 acts as an input shaft to the planetary gear set 220. A first bearing 254 supports the sun gear 230. A pair of second bearings 258A, 258B support the wheel shaft 250. A first seal 264 receives the sub gear 230. A second seal 268 receives the wheel shaft 250. As the wheel-end planetary reducer 40 is a modular component, the seals 264 and 268 retain fluid within the unit.

A first coupling 270 couples the CV shaft 244 to the sun gear 230. A second coupling 272 couples the wheel shaft 250 to the drive wheel 70. The first and second couplings 270, 272 can be any couplings suitable to connect the respective components. It is contemplated that the couplings can include one or more flanges, snap rings and/or bolts that mechanically connect the respective components. Those skilled in the art will appreciate that the first and second couplings 270, 272 can be configured in any manner suitable to couple the respective components while allowing ease of serviceability.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric drive system for an electrified vehicle, the electric drive system comprising:
a driveline including a first drive shaft that drives a first drive wheel and a second drive shaft that drives a second drive wheel;
a first electric motor having a first primary output shaft;
a first wheel-end planetary reducer provided at the first drive wheel, the first wheel-end planetary reducer providing a first gear reduction from the first drive shaft to a first wheel shaft at the first drive wheel; and
a second wheel-end planetary reducer provided at the second drive wheel, the second wheel-end planetary reducer providing a second gear reduction from the second drive shaft to a second wheel shaft at the second drive wheel;
wherein the first and second wheel-end planetary reducers are modular and removable between respective drive shafts and wheel shafts.

2. The electric drive system of claim 1, wherein the first wheel-end planetary reducer comprises a first housing that houses a planetary gear set including a sun gear, a carrier that supports a plurality of pinion gears, and a ring gear.

3. The electric drive system of claim 2, further comprising a first coupling that couples the first drive shaft to the sun gear.

4. The electric drive system of claim 3, further comprising a second coupling that couples the first wheel shaft to the first drive wheel.

5. The electric drive system of claim 4, further comprising a first bearing that supports the sun gear.

6. The electric drive system of claim 5, further comprising at least one second bearing that supports the first wheel shaft.

7. The electric drive system of claim 1, wherein the first and second gear reductions are equivalent.

8. The electric drive system of claim 7, wherein the first and second gear reductions both comprise one of 6:1; 7:1; and 8:1 gear ratios.

9. The electric drive system of claim 1, further comprising:
a second electric motor having a second primary output shaft; and
a third electric motor positioned between the first and second electric motors, the third electric motor having a first output shaft that provides a first torque input to the first motor and a second output shaft that provides a second torque input to the second motor.

10. The electric drive system of claim 9, further comprising:
a differential disposed in the third electric motor, the differential providing selective speed differentiation between the first and second output shafts.

11. The electric drive system of claim 10, wherein the differential comprises a first side gear that drives the first output shaft, a second side gear that drives the second output shaft and a plurality of planet gears that are meshed for rotation with the first and second side gears.

12. The electric drive system of claim 11, wherein the first, second and third electric motors are co-axially arranged on a rear axle of the electrified vehicle.

13. The electric drive system of claim 11, wherein the first, second and third electric motors are co-axially arranged on a front axle of the electrified vehicle.

14. The electric drive system of claim 9, wherein the first electric motor drives the first drive shaft and the second electric motor drives the second drive shaft, the first and second electric motors providing torque vectoring between the first and second drive wheels.

15. An electric drive system for an electrified vehicle, the electric drive system comprising:
a driveline including a first drive shaft that drives a first drive wheel and a second drive shaft that drives a second drive wheel;
a first electric motor having a first primary output shaft;
a pair of first wheel-end planetary reducers each having a first gear ratio reduction; and
a pair of second wheel-end planetary reducers each having a second gear ratio reduction;
wherein the electric drive system is configurable in each of:
a first configuration for achieving the first gear ratio reduction, wherein one of the pair of first wheel-end planetary reducers is installed between the first drive shaft and the first drive wheel and the other of the pair of first wheel-end planetary reducers is installed between the second drive shaft and the second drive wheel; and
a second configuration for achieving the second gear ratio reduction, wherein one of the pair of second wheel-end planetary reducers is installed between the first drive shaft and the first drive wheel and the other of the pair of second wheel-end planetary reducers is installed between the second drive shaft and the second drive wheel.

16. The electric drive system of claim 15, wherein the first gear ratio reduction is distinct from the second gear ratio reduction.

17. The electric drive system of claim 15, wherein the first wheel-end planetary reducer comprises a first housing that houses a planetary gear set including a sun gear, a carrier that supports a plurality of pinion gears, and a ring gear.

18. The electric drive system of claim 17, further comprising a first coupling that couples the first drive shaft to the sun gear.

19. The electric drive system of claim 18, further comprising a second coupling that couples the first wheel shaft to the first drive wheel.
